(19) United States
(12) Patent Application Publication
(10) Pub. No.: US 2025/0388250 A1
(43) Pub. Date: Dec. 25, 2025

(54) Smartbarrow powered Wheelbarrow Kit

(71) Applicant: Benjamin P Esh, Lancaster, PA (US)

(72) Inventor: Benjamin P Esh, Lancaster, PA (US)

(21) Appl. No.: 18/751,541

(22) Filed: Jun. 24, 2024

(51) Int. Cl. B62B 1/20; B62B 5/00

(52) U.S. Cl. CPC B62B 1/20; B62B 5/004; B62B 5/005

(57) ABSTRACT

A kit for converting a conventional wheelbarrow into a powered wheelbarrow, featuring a powered wheel, battery/controller plate, thumb throttle, and mounting brackets. The kit is uniquely powered by cordless tool batteries, providing a convenient and efficient solution for reducing manual labor in transporting heavy loads with a wheelbarrow.

### CROSS-REFERENCE TO RELATED APPLICATIONS

Not Applicable

### STATEMENT REGARDING FEDERALLY SPONSORED RESEARCH OR

DEVELOPMENT

Not Applicable

### BACKGROUND OF THE INVENTION

This invention relates to a kit for converting a traditional manual wheelbarrow into a powered wheelbarrow. More specifically, it involves a powered wheel, a battery/controller plate, a thumb throttle, and the necessary mounting brackets and cabling to integrate these components into an existing wheelbarrow structure. This conversion kit aims to ease the manual labor involved in operating a wheelbarrow, making it more accessible and efficient for various tasks. and productivity.

### Description of Related Art Including Information Disclosed Under 37 CFR 1.97 and 1.98

The prior art pertains to various wheelbarrow innovations. The prior art specifically, describes a powered wheelbarrow with a gear-based drive system rotating about a vertical axis. Prior art, furthermore, includes a motorized hand truck capable of coupling with a wheelbarrow for transport. Moreover, it encompasses a powered wheelbarrow equipped with a drive unit designed for bucket tipping, as well as variations with electric motors. Additionally, the prior art details a motorized wheelbarrow featuring a centrally located pivot point on the bucket to facilitate easier tipping.

Unique Feature: One distinguishing feature of this kit is its compatibility with two cordless tool batteries, leveraging their widespread availability and interchangeable nature. This design choice enhances convenience for users who already own such batteries, minimizing additional investment in new power sources.

### SUMMARY OF THE INVENTION

The present invention provides a comprehensive kit that can be easily installed on any conventional wheelbarrow to convert it into a powered wheelbarrow. The kit consists of the following components:
1. Powered Wheel and Mounting Brackets: A motorized wheel designed to replace the standard wheel of the wheelbarrow, including mounting brackets to secure it to the wheelbarrow frame.
2. Battery/Controller Plate: A separate unit that houses the battery and controller, mounted between the handles of the wheelbarrow.
3. Thumb Throttle and Mounting Bracket: A throttle mechanism that can be mounted on one of the wheelbarrow handles, allowing the user to control the speed and power of the motorized wheel.
4. Cordless Tool Battery Integration: The unique feature of this invention is its compatibility with cordless tool batteries, providing a versatile and widely available power source.
5. Short Cable Raceway and Cable Clamps: To guide the cables from the powered wheel to the battery/controller plate efficiently.
6. Long Cable Raceway: To connect the battery/controller plate to the thumb throttle.

### DETAILED DESCRIPTION OF THE INVENTION

### Components

1. Powered Wheel and Mounting Brackets:
   The powered wheel comprises a robust motor encased within the wheel structure. It is designed to fit into the standard axle slots of a wheelbarrow.
   Mounting brackets are provided to securely attach the powered wheel to the wheelbarrow, ensuring stability and proper alignment.
2. Battery/Controller Plate:
   This plate is designed to be mounted between the handles of the wheelbarrow. It includes slots for securing the battery and the electronic controller.
   The controller regulates the power supply from the battery to the motorized wheel, providing smooth and controllable operation.
3. Thumb Throttle and Mounting Bracket:
   The thumb throttle is an ergonomic device that allows the user to adjust the speed of the wheelbarrow using a thumb-operated lever.
   A mounting bracket is included to attach the throttle to one of the wheelbarrows handles within easy reach of the user.
4. Cordless Tool Battery Integration:
   The kit is designed to be compatible with standard cordless tool batteries, which are readily available and easily rechargeable. This feature enhances the convenience and accessibility of the powered wheelbarrow.
5. Short Cable Raceway and Cable Clamps:
   A short cable raceway is provided to protect and guide the cables from the powered wheel to the battery/controller plate.
   Cable clamps are included to secure the cables along the frame of the wheelbarrow, preventing tangling and damage.
6. Long Cable Raceway:
   A long cable raceway is provided to connect the battery/controller plate to the thumb throttle, ensuring the cables are neatly routed and protected from external elements.

### Assembly and Operation

1. Assembly:
   Replace the standard wheel of the wheelbarrow with the powered wheel using the provided mounting brackets.
   Install the battery/controller plate between the handles of the wheelbarrow, securing it firmly in place.
   Attach the thumb throttle to one of the wheelbarrow handles using the mounting bracket.
   Route the cables from the powered wheel to the battery/controller plate using the short cable raceway and cable clamps.
   Connect the long cable raceway from the battery/controller plate to the thumb throttle.
   Insert a compatible cordless tool battery into the battery slot on the battery/controller plate.
2. Operation:
   Once assembled, the powered wheelbarrow is ready for use. The user can control the speed and power of the wheelbarrow by operating the thumb throttle.
   The motorized wheel assists in propelling the wheelbarrow, reducing the manual effort required to transport heavy loads.

### BRIEF DESCRIPTION OF DRAWINGS:

FIG. 1: Perspective view of the powered wheel kit showing the battery/controller plate mounted underneath the wheelbarrow and between the handles of the wheelbarrow.

FIG. 2: Side view of the powered wheel kit showing powered wheel with mounting brackets, the battery/control plate mounted and the thumb throttle.

### DETAILED DESCRIPTION OF THE DRAWING

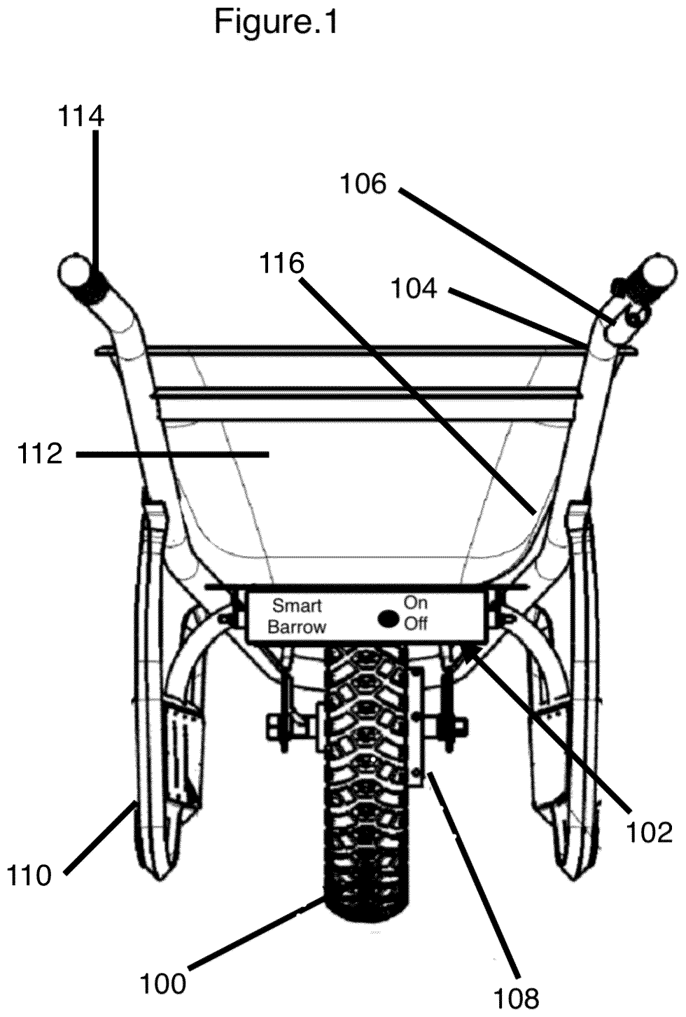

FIG. 1: This diagram illustrates the preferred configuration of a kit for a powered wheelbarrow, highlighting its key structural components: 100 a powered wheel with an integrated motor, 108 mounting brackets for the powered wheel, and a support frame 112 that includes 110 two support legs. 112 support frame also features 114 plastic handles positioned directly above 106 thumb throttle, securely affixed to the support frame and mounted via a bracket 104 to 112 supporting frame. A load-carrying container 112 is the top layer of the support frame, just below is the 102 housing for two tool batteries and control unit. 116 wiring cables are shown connecting to the 106 thumb throttle, with a mounting bracket 104 used to attach the 106 to the handle of the wheelbarrow.

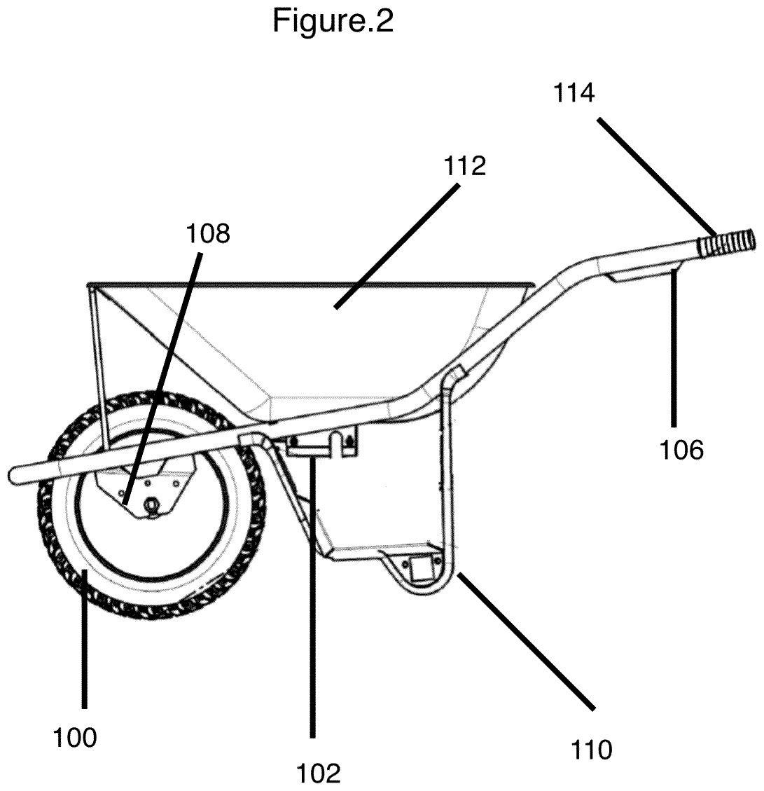

FIG. 2: shows a side view showing the 100 powered wheel. 108: A mounting bracket for the powered wheel 112: A support frame of the wheelbarrow. 110: Two support legs, which are part of the support frame. 114: Plastic handles positioned directly above. 106: A thumb throttle fixed to the support frame. 104: A mounting bracket for the thumb throttle. 112: A container for transporting loads, attached to the supporting frame. 102: A battery housing and a control unit housing.

### Conclusion

In conclusion, the kit for converting an ordinary wheelbarrow into a powered wheelbarrow represents a significant advancement in the field of manual material handling. Its innovative design and use of cordless tool battery technology provide a practical solution for improving efficiency and reducing physical strain in various applications.

What is claimed:

1. A kit for converting a conventional wheelbarrow into a powered wheelbarrow, comprising:
A powered wheel with an integrated motor;
Mounting brackets for securing the powered wheel to a wheelbarrow frame;
A battery/controller plate designed to be mounted between the handles of the wheelbarrow;
A thumb throttle with an ergonomic design for user operation;
A mounting bracket for attaching the thumb throttle to the wheelbarrow handle;
A short cable raceway and cable clamps for guiding cables from the powered wheel to the battery/controller plate;
A long cable raceway for connecting the battery/controller plate to the thumb throttle;
The powered wheel being operable by a cordless tool battery.

2. The kit of claim 1, wherein the cordless tool battery is a rechargeable battery compatible with standard cordless power tools.

3. The kit of claim 1, further comprising:
Cable clamps for securing the cables along the wheelbarrow frame, preventing tangling and damage during operation.
